(19) United States
(12) Patent Application Publication
(10) Pub. No.: US 2019/0024484 A1
(43) Pub. Date: Jan. 24, 2019

(54) INDEPENDENT AND RECHARGEABLE POWER SUPPLY FOR A BOTTOM HOLE ASSEMBLY

(71) Applicant: Halliburton Energy Services, Inc., Houston, TX (US)

(72) Inventors: Satish Rajagopalan, Tomball, TX (US); Clint P. Lozinsky, Kingwood, TX (US)

(73) Assignee: Halliburton Energy Services, Inc., Houston, TX (US)

(21) Appl. No.: 15/745,642

(22) PCT Filed: Nov. 30, 2016
(86) PCT No.: PCT/US2016/064229

§ 371 Date: Jan. 17, 2018

(51) Int. Cl. E21B 41/00; E21B 4/02

(52) U.S. Cl. CPC E21B 41/0085; H02M 7/02; E21B 4/02

(57) ABSTRACT

A system and method for powering a bottom hole assembly. A system may comprise a turbine and an alternator, in which the turbine is connected to the alternator. An AC-DC converter wherein the AC-DC converter is connected to the alternator. A subbus, configured to supply the DC current along the subbus to power the bottom hole assembly. An ultracapacitor and a bidirectional DC-DC converter. The method may comprise introducing a bottom hole assembly into a wellbore, pumping a drilling fluid into the wellbore, and activating a turbine of the bottom hole assembly with the drilling fluid such that power is generated to power one or more components of the bottom hole assembly and charge an ultracapacitor of the bottom hole assembly. Activating the ultracapacitor and powering the bottom hole assembly with the ultracapacitor during a period that the turbine is not activated with the drilling fluid.

### BACKGROUND

Wellbores drilled into subterranean formations may enable recovery of desirable fluids (e.g., hydrocarbons) using a number of different techniques. During operation, any number of different bottom hole assemblies may be utilized to recover desirable fluids. Without limitation, logging while drilling (LWD) tools, measurement while drilling (MWD) tools, electromagnetic induction tools, and/or telemetry tools may be implemented during downhole operations. During operation, bottom hole assemblies may be powered by a turbine-driven alternator power system that may be disposed with the bottom hole assembly. However, the turbine-driven alternator power system may operate as mud may be pumped into the wellbore. During drilling operations, the bottom hole assembly may be stopped, which may also prevent the pumping of mud. The bottom hole assembly may then rely on batteries to power the bottom hole assembly when mud may not be pumped downhole.

Batteries may be expensive to procure, store and dispose of. In addition, most batteries utilized in drilling operations may not be rechargeable and may only be used one time. This may limit the length and number of runs a bottom hole assembly powered by a battery may perform. Battery stacks may be big, suffer from temperature-based limits in drilling operations, and may add additional length to the bottom hole assembly.

### BRIEF DESCRIPTION OF THE DRAWINGS

These drawings illustrate certain aspects of some examples of the present disclosure, and should not be used to limit or define the disclosure.

FIG. 1 is a schematic illustration of an example of a drilling system with a bottom hole assembly in a wellbore;

FIG. 2 is a flow chart of current through a power generation system in a bottom hole assembly;

FIG. 3 is a flow chart of current through a power generation system in a bottom hole assembly to charge an ultracapacitor;

FIG. 4 is a flow chart of current through a power generation system in a bottom hole assembly when the ultracapacitor discharges stored energy; and

FIG. 5 is a flow chart of current through a power generation system in a bottom hole assembly from the ultracapacitor directly to sensors.

### DETAILED DESCRIPTION

Certain aspects and features of the disclosure may be directed to drilling operations and, more particulars, to bottom hole assemblies that use a capacitor as an independent and rechargeable power supply. Without limitation, a capacitor may comprise an ultracapacitor, a supercapacitor, hybrid capacitor, and/or electrical double-layer capacitor. Currently, batteries may be utilized to power bottom hole assemblies during drilling operations when no mud may be flowing downhole. Ultracapacitors may be a battery independent solution to powering bottom hole assemblies. An ultracapacitor may be a high-capacity electrochemical capacitor with capacitance values that may be higher than other capacitors with lower voltage limits. In examples, ultracapacitors may store between ten and one hundred times more energy per unit volume and/or mass than electrolytic capacitors, and may accept and deliver charge much faster than batteries. Additionally, ultracapacitors may be rated for high temperature, shock, and vibration, thus making them particularly suited for use in drilling operations.

Systems and methods of the present disclosure may be implemented, at least in part, with an information handling system. An information handling system may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Alternatively, systems and methods of the present disclosure may be implemented, at least in part, with non-transitory computer-readable media. Non-transitory computer-readable media may include any instrumentality or aggregation of instrumentalities that may retain data and/or instructions for a period of time. Non-transitory computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

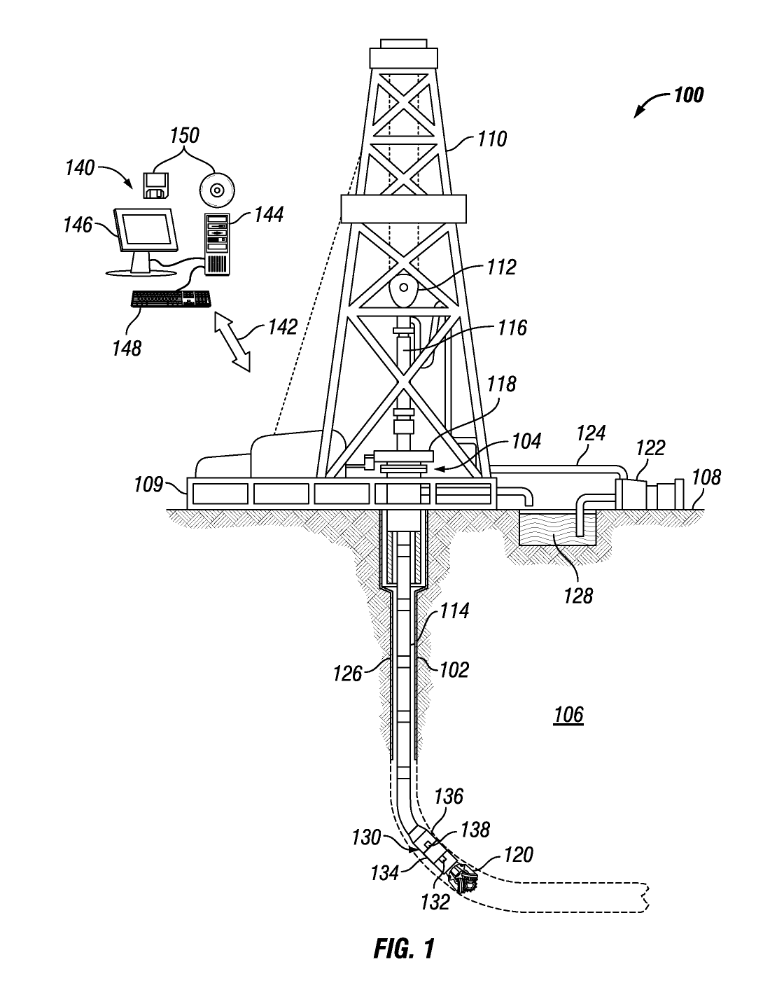

FIG. 1 illustrates a drilling system 100. As illustrated, wellbore 102 may extend from a wellhead 104 into a subterranean formation 106 from a surface 108. Generally, wellbore 102 may include horizontal, vertical, slanted, curved, and other types of wellbore geometries and orientations. Wellbore 102 may be cased or uncased. In examples, wellbore 102 and may comprise a metallic material that may be conductive and magnetic. By way of example, conductive and magnetic member may be a casing, liner, tubing, or other elongated steel tubular disposed in wellbore 102.

As illustrated, wellbore 102 may extend through subterranean formation 106. As illustrated in FIG. 1, wellbore 102 may extending generally vertically into the subterranean formation 106, however wellbore 102 may extend at an angle through subterranean formation 106, such as horizontal and slanted wellbores. For example, although FIG. 1 illustrates a vertical or low inclination angle well, high inclination angle or horizontal placement of the well and equipment may be possible. It should further be noted that while FIG. 1 generally depicts a land-based operation, those skilled in the art may recognize that the principles described herein are equally applicable to subsea operations that employ floating or sea-based platforms and rigs, without departing from the scope of the disclosure.

As illustrated, a drilling platform 109 may support a derrick 110 having a traveling block 112 for raising and lowering drill string 114. Drill string 114 may include, but is not limited to, drill pipe and coiled tubing, as generally known to those skilled in the art. A kelly 116 may support drill string 114 as it may be lowered through a rotary table 118. A drill bit 120 may be attached to the distal end of drill string 114 and may be driven either by a downhole motor and/or via rotation of drill string 114 from the surface 108. Without limitation, drill bit 120 may include, roller cone bits, PDC bits, natural diamond bits, any hole openers, reamers, coring bits, and the like. As drill bit 120 rotates, it may create and extend wellbore 102 that penetrates various subterranean formations 106. A pump 122 may circulate drilling fluid through a feed pipe 124 to kelly 116, downhole through interior of drill string 114, through orifices in drill bit 120, back to surface 108 via annulus 126 surrounding drill string 114, and into a retention pit 128.

With continued reference to FIG. 1, drill string 114 may begin at wellhead 104 and may traverse wellbore 102. Drill bit 120 may be attached to a distal end of drill string 114 and may be driven, for example, either by a downhole motor and/or via rotation of drill string 114 from surface 108. Drill bit 120 may be a part of bottom hole assembly 130 at distal end of drill string 114. Bottom hole assembly 130 may further comprise one or more of a turbine 132 (e.g. mud motor), alternator 134, AC-DC converter 136, and/or a capacitor, illustrated as ultracapacitor 138. It should be noted, as discussed above, the capacitor may be any type of capacitors. Although not illustrated, bottom hole assembly 130 may comprise a power module, steering module, telemetry subassembly, and/or other sensors and instrumentation as will be appreciated by those of ordinary skill in the art. As will be appreciated by those of ordinary skill in the art, bottom hole assembly 130 may be a measurement-while drilling (MWD) or logging-while-drilling (LWD) system.

Without limitation, bottom hole assembly 130 may be connected to and/or controlled by information handling system 140, which may be disposed on surface 108. Without limitation, information handling system 140 may be disposed down hole in bottom hole assembly 130. In examples, information handling system 140 may communicate with bottom hole assembly 130 through a communication line (not illustrated) disposed in (or on) drill string 114. In examples, wireless communication may be used to transmit information back and forth between information handling system 140 and bottom hole assembly 130. Information handling system 140 may transmit information to bottom hole assembly 130 and may receive as well as process information recorded by bottom hole assembly 130. In examples, a downhole information handling system (not illustrated) may include, without limitation, a microprocessor or other suitable circuitry, for estimating, receiving and processing signals from bottom hole assembly 130. Downhole information handling system (not illustrated) may further include additional components, such as memory, input/output devices, interfaces, and the like. In examples, while not illustrated, bottom hole assembly 130 may include one or more additional components, such as analog-to-digital converter, filter and amplifier, among others, that may be used to process the measurements of bottom hole assembly 130 before they may be transmitted to surface 108. Alternatively, raw measurements from bottom hole assembly 130 may be transmitted to surface 108.

Any suitable technique may be used for transmitting signals from bottom hole assembly 130 to surface 108, including, but not limited to, wired pipe telemetry, mud-pulse telemetry, acoustic telemetry, and electromagnetic telemetry. While not illustrated, bottom hole assembly 130 may include a telemetry subassembly that may transmit telemetry data to surface 108. Without limitation, an electromagnetic source in the telemetry subassembly may be operable to generate pressure pulses in the drilling fluid that propagate along the fluid stream to surface 108. At surface 108, pressure transducers (not shown) may convert the pressure signal into electrical signals for a digitizer (not illustrated). The digitizer may supply a digital form of the telemetry signals to information handling system 140 via a communication link 142, which may be a wired or wireless link. The telemetry data may be analyzed and processed by information handling system 140.

As illustrated, communication link 142 (which may be wired or wireless, for example) may be provided that may transmit data from bottom hole assembly 130 to an information handling system 140 at surface 108. Information handling system 140 may include a processing unit 144, a monitor 146, an input device 148 (e.g., keyboard, mouse, etc.), and/or computer media 150 (e.g., optical disks, magnetic disks) that can store code representative of the methods described herein. In addition to, or in place of processing at surface 108, processing may occur downhole.

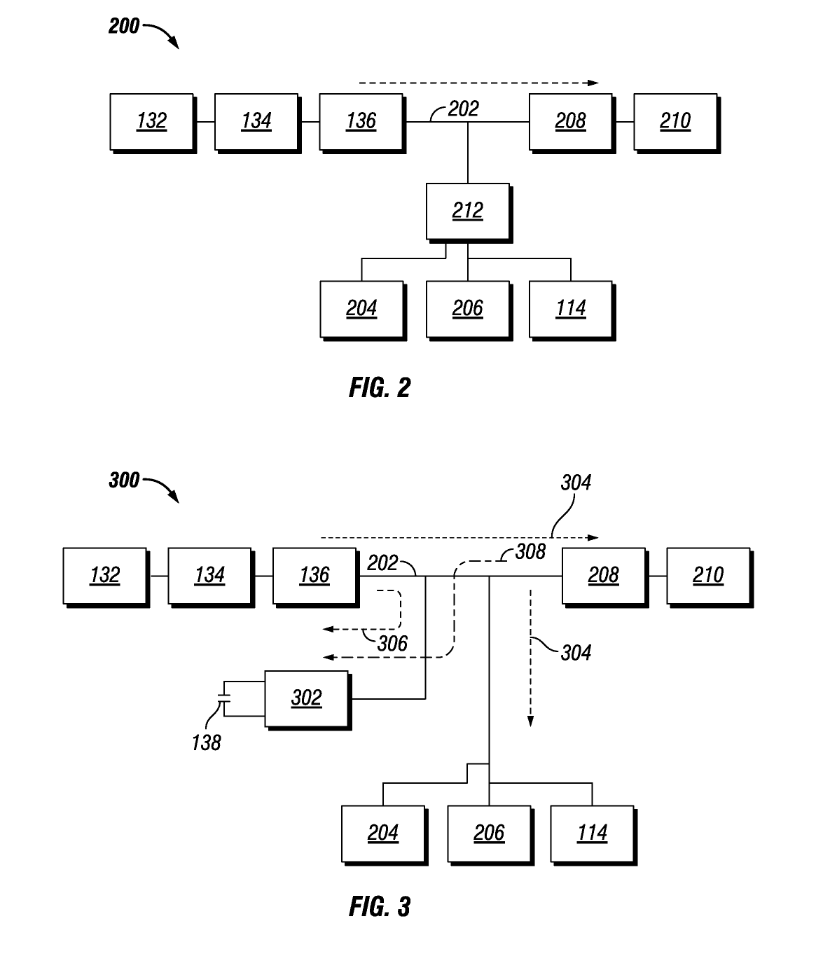

FIG. 2 illustrates a flow chart of current in a power generation system 200 of bottom hole assembly 130 (not illustrated). Power generation system 200 may comprise turbine 132, alternator 134, AC-DC converter 136, subbus 202, sensors 204, telemetry device 206, DC to AC converter 208, electronic loads 210, and/or batteries 212. Without limitation, turbine 132 (Referring to FIG. 1), which may rotate as drilling fluid (e.g. mud) may be circulated through wellbore 102 and turbine 132 during drilling operations. Turbine 132 may be coupled to alternator 134. Spinning turbine 132 with drilling fluid may create power through alternator 134 (Referring to FIG. 1). As alternator 134 spins, it may create an AC current. Alternator 134 may be connected to AC-DC converter 136. AC current from alternator 134 may be converted into DC current by AC-DC converter 136. AC-DC converter 136 may convert AC current from alternator 134 to DC current for use within bottom hole assembly 130. It should be noted that current may flow along bottom hole assembly 130 through a subbus 202. Without limitation, subbus 202 may act as a conduit in which AC and/or DC current may flow in any direction along bottom hole assembly 130. DC current may flow to DC powered equipment such as sensors 204, telemetry device 206 within drill string 114 (Referring to FIG. 1). Without limitation, DC current may be transformed into AC current with a DC to AC converter 208. AC current may then be utilized in other additional electronic loads 210. Without limitation, electronic loads 210 may be rotating, oscillating, pulsating, and/or static, such as pulsers, MWD tools, drilling tool actuators, and/or the like.

During drilling operations, drilling pipes (not illustrated) may be continuously added. When a drill pipe section may be added, pumps 122 (Referring to FIG. 1) circulating the mud may be switched off. Pumps 122 may then be restarted when the drilling resumes. During the time in which pumps 122 may be off, no power may be provided from turbine based power generation system 200. Power may be supplied by batteries 212, which may be disposed on bottom hole assembly 130. Batteries 212 may be primary batteries that may not be recharged. The use of batteries 212 therefore may limit the length of the run and the performance of sensors 204. As illustrated in FIG. 2, batteries 212 may power sensors 204, telemetry devices 206, drill string 114, survey tools, and/or the like. The cost to procure, maintain, and store batteries 212 at a drilling site may add additional cost to drilling operations.

FIG. 3, illustrates an alternative design in which ultracapacitor 138 (Referring to FIG. 1) may be utilized in place of batteries 212 (Referring to FIG. 2). It should be noted that there may be a plurality of ultracapacitor 138 in a bank of ultracapacitor 138 to power bottom hole assembly 130. Referring to FIG. 3, power generation system 300 may comprise turbine 132, alternator 134, AC-DC converter 136, subbus 202, sensors 204, telemetry device 206, drill string 114 (Referring to FIG. 1), DC to AC converter 208, and/or electronic loads 210 (Referring to FIGS. 1 and 2). In addition, power generation system 300 may further comprise an ultracapacitor 138 and/or a bidirectional DC-DC converter 302. In drilling operations, arrows 304 illustrates the movement of current supplied by turbine 132 and alternator 134 that may provide power to sensors 204, telemetry devices 206, DC to AC converter 208, and/or electronic loads 210. Additionally, arrow 306 illustrates the movement of current supplied by turbine 132 and alternator 134 that may charge ultracapacitor 138 through bidirectional DC-DC converter 302. In examples, arrow 308 illustrates the movement of regenerative energy from DC to AC converter 208 and electronic loads 210, which may charge ultracapacitor 138.

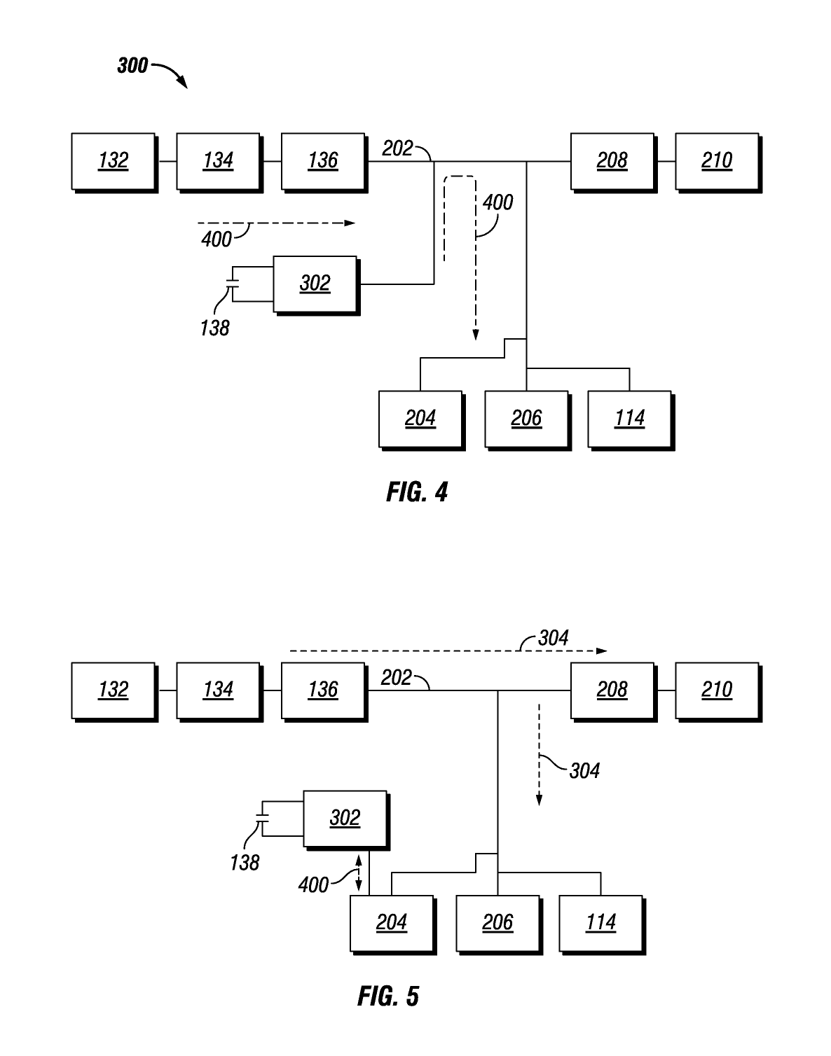

During drilling operations when pumps 122 have been shut off and no mud may be spinning turbine 132, ultracapacitor 138 may discharge the stored energy into bottom hole assembly 130 through bidirectional DC-DC converter 302. FIG. 4 illustrates drilling operations in which ultracapacitor 138 supplies power to power generation system 300. Arrows 400 illustrate the movement of current along subbus 202 from ultracapacitor 138 through bidirectional DC-DC converter 302 to power sensors 204, telemetry devices 206, and/or drill string 114 (Referring to FIG. 1).

Without limitation, bidirectional DC-DC converter 302 may be controlled by information handling system 140. Without limitation, information handling system 140 may be disposed on surface 108 (Referring to FIG. 1) and/or downhole on bottom hole assembly 130 (Referring to FIG. 1). In examples, information handling system 140 may allow power to flow to ultracapacitor 138 through bidirectional DC-DC converter 302 for charging and/or allow power to flow out of ultracapacitor 138 and through bidirectional DC-DC converter 302 to bottom hole assembly 130. Bidirectional DC-DC converter 302 may act as a gateway, controlled by information handling system 140, which may control the flow of power to and/or from ultracapacitor 138. In examples, bidirectional DC-DC converter 302 may be manufactured and/or have setting which may allow an operator to choose a threshold voltage which may control the power moving through bidirectional DC-DC converter 302. For example, if voltage drops below a programmed and/or selected voltage threshold, bidirectional DC-DC converter 302 may allow power to flow from ultracapacitor 138 into bottom hole assembly 130. If voltage rises above the programmed and/or selected voltage threshold, bidirectional DC-DC converter 302 may allow power to flow from alternator 134 into ultracapacitor 138 to charge ultracapacitor 138. In examples, ultracapacitor 138 may comprise enough power to power bottom hole assembly 130 for any amount of time while pumps 122 may be turned off and/or when bottom hole assembly 130 may be malfunctioning.

FIG. 5 illustrates an example in which bidirectional DC-DC converter 302 may be tied to a specific sensor 204. In additional examples, bidirectional DC-DC converter 302 may attached to low voltage or high voltage tools and/or boards. Arrow 400 illustrates the movement of current from ultracapacitor 138 through bidirectional DC-DC converter 302 to sensors 204 and/or a specific sensor 204.

Accordingly, this disclosure describes systems and methods that may be used for powering a bottom hole assembly. Without limitation, the systems and method may further be characterized by one or more of the following statements:

Statement 1: A power generation system for a bottom hole assembly comprising: a turbine; an alternator, wherein the turbine is connected to the alternator; an AC-DC converter, wherein the AC-DC converter is connected to the alternator, which is configured to convert AC current from the alternator to DC current; a subbus, configured to supply the DC current along the subbus to power the bottom hole assembly; an ultracapacitor; and a bidirectional DC-DC converter.

Statement 2: The system of statement 1 wherein the turbine is a mud motor.

Statement 3: The system of statement 1 or statement 2 further comprising an information handling system configured to operate the bidirectional DC-DC converter to allow power to flow from the bottom hole assembly to the ultracapacitor.

Statement 4: The system of any preceding statement wherein the information handling system operates the bidirectional DC-DC converter to allow power to flow from the ultracapacitor to the bottom hole assembly.

Statement 5: The system of any preceding statement wherein the bidirectional DC-DC converter is configured with a voltage threshold.

Statement 6: The system of statement 5 wherein the bidirectional DC-DC converter allows power to flow from the bottom hole assembly to the ultracapacitor when a voltage along the bottom hole assembly is above the voltage threshold.

Statement 7: The system of statement 5 wherein the bidirectional DC-DC converter allows power to flow from the ultracapacitor to the bottom hole assembly when a voltage along the bottom hole assembly is below the voltage threshold.

Statement 8: The system of any preceding statement wherein the ultracapacitor selectively powers a sensor or a telemetry device.

Statement 9: The system of any preceding statement wherein the power generation system comprises a bank of ultracapacitors to power the bottom hole assembly.

Statement 10: The system of any preceding statement wherein an information handling system is disposed on the surface or on the bottom hole assembly.

Statement 11: A method for powering a bottom hole assembly comprising: introducing the bottom hole assembly into a wellbore; pumping a drilling fluid into the wellbore; activating a turbine of the bottom hole assembly with the drilling fluid such that power is generated to power one or more components of the bottom hole assembly and charge an ultracapacitor of the bottom hole assembly; activating the ultracapacitor; and powering the bottom hole assembly with the ultracapacitor during a period that the turbine is not activated with the drilling fluid.

Statement 12: The method of statement 11 comprising operating a bidirectional DC-DC converter to allow power to flow to the ultracapacitor.

Statement 13: A method of statement 11 or statement 12 comprising operating a bidirectional DC-DC converter to allow power to flow from the ultracapacitor to one or more components of the bottom hole assembly.

Statement 14: A method of statement 11 or statement 12 configuring a bidirectional DC-DC converter with a voltage threshold.

Statement 15: A method of statement 14 further comprising activating the bidirectional DC-DC converter to allow power to flow from the bottom hole assembly to the ultracapacitor when a voltage along the bottom hole assembly is above the voltage threshold.

Statement 16: The method of statement 14 activating the bidirectional DC-DC converter to allow power to flow from the ultracapacitor to the bottom hole assembly when a voltage along the bottom hole assembly is below the voltage threshold.

Statement 17: The method of any one of statements 11 to 16 wherein activating the ultracapacitor is controlled by an information handling system disposed on the surface or the bottom home assembly.

Statement 18: The method of any one of statements 11 to 17 wherein the turbine is a mud motor.

Statement 19: The method of any one of statements 11 to 18 wherein the one or more components powered by the turbine comprise a sensor or a telemetry device.

Statement 20: The method of any one of statements 11 to 19 comprising powering the bottom hole assembly with a bank of ultracapacitors.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A power generation system for a bottom hole assembly comprising:
a turbine;
an alternator, wherein the turbine is connected to the alternator;
an AC-DC converter, wherein the AC-DC converter is connected to the alternator, wherein the AC-DC converter is configured to convert AC current from the alternator to DC current;
a subbus, configured to supply the DC current along the subbus to power the bottom hole assembly;
an ultracapacitor; and
a bidirectional DC-DC converter.

2. The system of claim 1, wherein the turbine is a mud motor.

3. The system of claim 1, further comprising an information handling system configured to operate the bidirectional DC-DC converter to allow power to flow from the bottom hole assembly to the ultracapacitor.

4. The system of claim 3, wherein the information handling system operates the bidirectional DC-DC converter to allow power to flow from the ultracapacitor to the bottom hole assembly.

5. The system of claim 1, wherein the bidirectional DC-DC converter is configured with a voltage threshold.

6. The system of claim 5, wherein the bidirectional DC-DC converter allows power to flow from the bottom hole assembly to the ultracapacitor when a voltage along the bottom hole assembly is above the voltage threshold.

7. The system of claim 5, wherein the bidirectional DC-DC converter allows power to flow from the ultracapacitor to the bottom hole assembly when a voltage along the bottom hole assembly is below the voltage threshold.

8. The system of claim 1, wherein the ultracapacitor selectively powers a sensor or a telemetry device.

9. The system of claim 1, wherein the power generation system comprises a bank of ultracapacitors to power the bottom hole assembly.

10. The system of claim 1, wherein an information handling system is disposed on the surface or on the bottom hole assembly.

11. A method for powering a bottom hole assembly comprising:
introducing the bottom hole assembly into a wellbore;
pumping a drilling fluid into the wellbore;
activating a turbine of the bottom hole assembly with the drilling fluid such that power is generated to power one or more components of the bottom hole assembly and charge an ultracapacitor of the bottom hole assembly;
activating the ultracapacitor; and
powering the bottom hole assembly with the ultracapacitor during a period that the turbine is not activated with the drilling fluid.

12. The method of claim 11, comprising operating a bidirectional DC-DC converter to allow power to flow to the ultracapacitor.

13. The method of claim 11, comprising operating a bidirectional DC-DC converter to allow power to flow from the ultracapacitor to one or more components of the bottom hole assembly.

14. The method of claim 11, comprising configuring a bidirectional DC-DC converter with a voltage threshold.

15. The method of claim 14, comprising activating the bidirectional DC-DC converter to allow power to flow from the bottom hole assembly to the ultracapacitor when a voltage along the bottom hole assembly is above the voltage threshold.

16. The method of claim 14, comprising activating the bidirectional DC-DC converter to allow power to flow from the ultracapacitor to the bottom hole assembly when a voltage along the bottom hole assembly is below the voltage threshold.

17. The method of claim 11, wherein activating the ultracapacitor is controlled by an information handling system disposed on the surface or the bottom home assembly.

18. The method of claim 11, wherein the turbine is a mud motor.

19. The method of claim 11, wherein the one or more components powered by the turbine comprise a sensor or a telemetry device.

20. The method of claim 11, comprising powering the bottom hole assembly with a bank of ultracapacitors.
